(19) United States
(12) Patent Application Publication
(10) Pub. No.: US 2008/0211325 A1
(43) Pub. Date: Sep. 4, 2008

(54) Electromotive Drive

(75) Inventors: Hans Peter Rienhardt, Neckarsulm (DE); Bernd Walther, Bietigheim-Bissingen (DE); Christof Heuberger, Markgroningen (DE)

Correspondence Address: MATTHEW R. JENKINS, ESQ., 2310 FAR HILLS BUILDING, DAYTON, OH, 45419, US

(73) Assignee: VALEO SYSTEMES D'ESSUYAGE, La Verriere (FR)

(21) Appl. No.: 10/596,172

(22) PCT Filed: Dec. 2, 2004
(86) PCT No.: PCT/EP04/13715

§ 371 Date: Jun. 2, 2006

(30) Foreign Application Priority Data
Dec. 5, 2003 (DE) 10357018.7

(51) Int. Cl. H02K 5/16; H02K 7/08; H02K 7/116

(52) U.S. Cl. 310/43; 310/89; 310/83; 310/90

(57) ABSTRACT

The invention relates to an electromotive drive comprising an electric motor with a commutator that is located in a motor housing, in addition to gearing that is flange-mounted on the electric motor. In the drive, the armature shaft passes through an opening into the interior chamber of a gearing housing. A screening element is fixed onto the shaft to rotate with the latter. The screening element almost completely seals the opening against abraded carbon particles or dust from the brushes. The screening element also carries a control magnet that co-operates with a sensor of the motor control module.

The invention relates to an electromotive drive, in particular to an auxiliary drive for use in vehicles, according to the preamble of claim 1. Electromotive auxiliary drives for use in vehicles, for example in windscreen wiper systems, electric window lift mechanisms, electric seat adjustment devices, etc., are known in various embodiments and usually consist of an electric motor and of gearing which is flanged-mounted on the electric motor or the housing thereof. The motor shaft or armature shaft of the electric motor passes through a through-opening from the interior of the motor housing into the gearing housing, and is mounted there in a bearing (ball bearing) in the region of the through-opening or on a housing flange which forms this through-opening.

In order to control and/or monitor the motor, particularly in the case of reversing drives, a control magnet is often also provided on the motor shaft within the gearing housing, which control magnet rotates with the motor shaft and cooperates with at least one sensor which is provided on a board within the gearing housing in the direct vicinity of the rotating path of the control magnet, said board forming a control circuit for the motor. The electric motors used in such auxiliary drives are in principle those in which the supply and control of the current takes place on the armature winding via a commutator and carbon brushes which cooperate therewith. In this case, it is impossible to avoid the situation whereby a not inconsiderable amount of abraded material, particularly carbon dust, is produced during operation of the motor, which may lead to damage to the bearing for the armature shaft but also passes into the interior of the gearing housing and deposits there as an electrically conductive layer inter alia on the board which forms the motor control system. In order to prevent short-circuits between contacts and/or conductor tracks, etc. on the board, it is necessary to cover this board, the contact faces and/or conductor tracks thereof and also the components themselves with a protective insulating layer, or else to screen the board from the interior of the gearing by means of an intermediate wall or to accommodate the board in a screened partial area of the gearing chamber. These measures are relatively complicated.

The object of the invention is to provide a drive which prevents damage to the bearing of the armature shaft and interference on the electrical motor control system in a particularly simple and cost-effective manner.

By virtue of the design according to the invention, a simple and cost-effective solution is provided for screening the gearing housing and the functional elements accommodated in this gearing housing, particularly the bearing for the shaft and the board, from abraded carbon particles or carbon dust. In one preferred embodiment of the invention, the screening element is at the same time another functional element, for example a carrier element for the at least one control magnet, or forms this control magnet. In principle, it is also possible that the screening element is provided on the commutator of the electric motor or forms part of this commutator.

The screening element is preferably an injection-moulded part made of plastic. If the control magnet forms part of the screening element, this can be produced by simple overmoulding of at least one permanent magnet which forms the control magnet.

Additional measures for protecting the board against carbon dust or abraded carbon particles, such as coating for example, that is to say covering the board, the conductor tracks and/or contacts thereon, the components, etc. with an insulating layer, are no longer required in the design according to the invention. In particular, there is also no need for any screening walls or screening covers for the board in the gearing housing.

Further developments of the invention form the subject matter of the dependent claims. The invention will be explained in more detail below with reference to the figures and on the basis of examples of embodiments. In the figures:

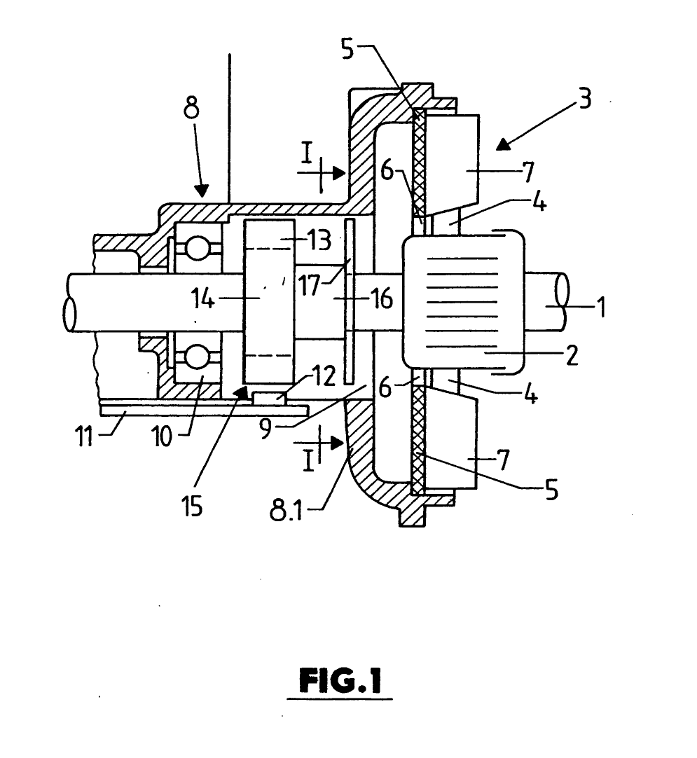

FIG. 1 shows a simplified partial diagram of the shaft of an electromotive drive together with a commutator, the brushes which cooperate with the commutator, and the mounting of the shaft in a gearing housing which is flange-mounted on the electric motor, together with a magnet with screening bushing which is provided on the shaft;

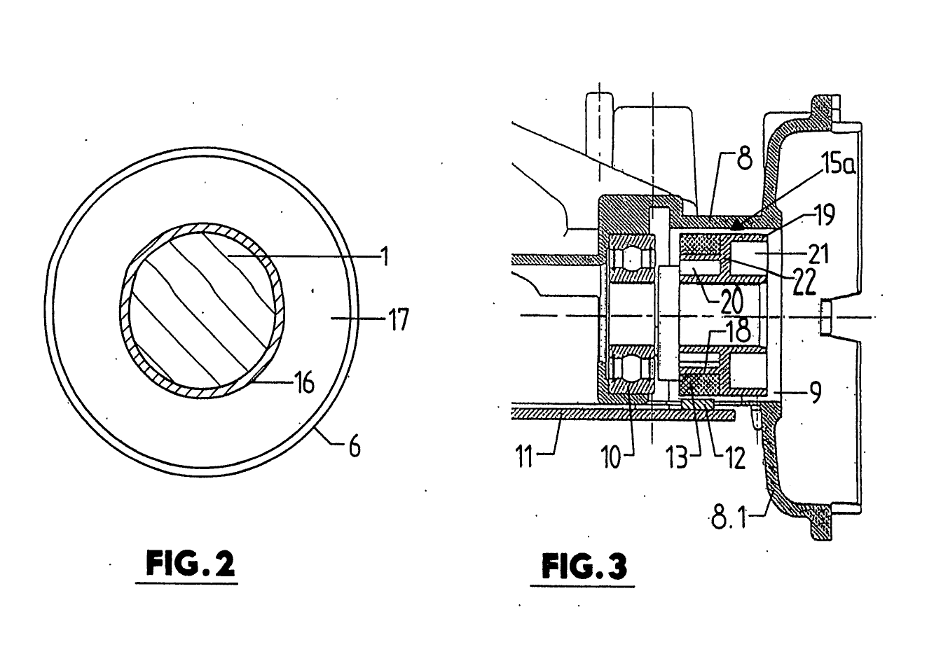

FIG. 2 shows a section along the line I-I in FIG. 1;

FIG. 3 shows a diagram similar to FIG. 1, but in the case of another embodiment;

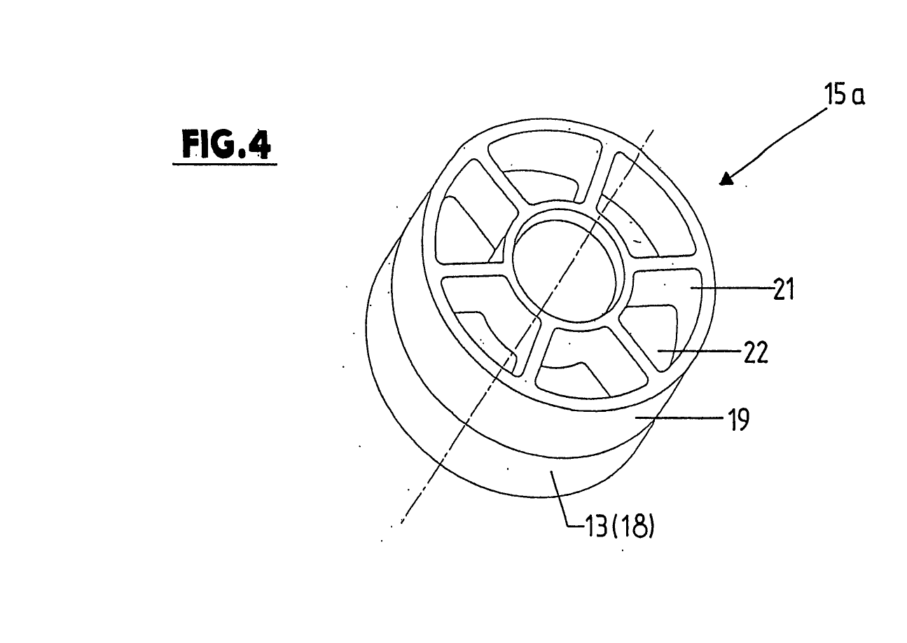

FIG. 4 shows a perspective diagram of the control magnet and the screening bushing of the embodiment in FIG. 3.

In FIGS. 1 and 2, reference 1 denotes the armature shaft of the electromotive auxiliary drive, for example of a reversing windscreen wiper drive, which essentially consists of an electric motor and of gearing which is flange-mounted on the housing of the electric motor.

Of the electric motor, FIGS. 1 and 2 show only the armature shaft 1, the commutator 2 which is arranged on the armature shaft 1 and rotates with this armature shaft, and the brush holder 3 for the carbon brushes 4 which cooperate with the commutator 2. The brush holder 3 consists in a known manner of a board 5, which includes inter alia a board opening 6 for the passage of the armature shaft 1, wherein inter alia two guides or supports for the containers 7 which form the brush holders 3 are provided on said board. The diameter of the board opening 6 is greater than the diameter of the armature shaft 1. The board 5 is held at its circumference in a bowl-shaped housing flange 8.1 of the gearing housing 8, namely in such a way that the board 5 is oriented with its surface sides perpendicular to the axis of the armature shaft 1. The housing (not shown) of the electric motor is closed on the gearing side by means of the flange 8.1.

The armature shaft 1 passes through a through-opening 9, which is provided in the housing flange 8.1, and into the interior of the gearing which is enclosed by the gearing housing 8, and is mounted inter alia in the gearing housing by means of the ball bearing 10. The bearing 10 is located within the gearing housing 8 at an axial distance from the through-opening 9 and from the housing flange 8.1.

A further board 11, which is arranged parallel to the axis of the armature shaft 1, is provided inside the gearing housing 8, said further board being designed for example as a printed circuit board and having a plurality of electrical components which serve to control the motor. Of these components, only one sensor 12 has been shown for the sake of simplicity, said sensor being designed for example as a Hall sensor or chip and cooperating with an annular control magnet 13 which is provided in an axis-parallel manner on the armature shaft 1 and rotates with the armature shaft 1. The control magnet 13, which has at least one, but preferably a number of permanent magnets in a ring made of plastic for example, serves to control and/or monitor the electric motor, for example to monitor and/or control the rotational speed and/or the reversing movement.

In order that the sensor 12 can cooperate with the control magnet 13 in the required manner, the control magnet 13 is located within the gearing housing at a distance from the through-opening 9, for which a relatively large cross section is required, since the bearing 10 and also the control magnet 13 have to be mounted through the through-opening 9.

In the illustrated embodiment, the control magnet 13 is located on a hub-shaped or disc-shaped section 14 of a screening element 15 which is produced as a moulded part made of plastic. Said screening element furthermore has a sleeve-shaped section 16, which projects away from an end side of the section 14, and also a disc-shaped section 17, which is integrally formed at the end of the section 16 which is remote from the section 14.

The screening element 15 is mounted on the armature shaft 1 so as to rotate therewith, and namely in such a way that the sections 14, 16 and 17 surround the armature shaft 1 and the disc-shaped section 17, which is oriented with its end faces perpendicular to the axis of the armature shaft 1, is located in the through-opening 9 and almost completely closes this opening, that is to say closes it up to an annular gap of small width. To this end, the circular disc-shaped section 17 has an outer diameter which is only slightly smaller than the diameter of the likewise circular through-opening 9, so that the interior of the gearing housing 8 is effectively protected against any ingress of dust from the carbon brushes by the disc 17 or by the screening element formed of the moulded part 15.

FIGS. 3 and 4 show a further possible embodiment of the invention in which, instead of the screening bushing or screening element 15, a screening bushing or screening element 15a is used which once again is produced as a moulded part made of plastic, namely with a section 18 with a cylindrical outer face, on which the control magnet 13 is arranged, and a section 19 which axially adjoins the section 18 and also has a cylindrical outer face, and in the mounted state extends into the through-opening 9 of the housing flange 8.1 with part of its axial length. The two sections 18 and 19 lie with their axes parallel to the axis of the armature shaft 1 (not shown in FIGS. 3 and 4). The outer diameter of the section 19 is only slightly smaller than the diameter of the through-opening 9. In this embodiment, too, the screening element 15a is located between the through-opening 9 and the bearing 10, which is provided within the gearing housing 8.

In order to reduce the weight and to save material, the two sections 18 and 19 are provided with a plurality of chambers 20 and 21, which are nevertheless closed by a central web in the interior of the screening element, said web running radially with respect to the axis of the screening element 15a.

The invention has been described above on the basis of examples of embodiments. It will be understood that numerous modifications and changes are possible without thereby departing from the concept on which the invention is based.

It has been assumed above that the respective screening element 15 or 15a is located in the region of the gearing housing 8 or housing flange 8.1, and the screening element at the same time serves as a carrier or hub for the control magnet 13. In principle, it is also possible that the screening element or screening bushing is produced in one piece with the control magnet. It is also possible for example that the screening element extends into the through-opening 9 from the motor side, and in this case is produced for example in one piece with the commutator 2 or the insulating body of this commutator.

It is also possible in principle to use the control magnet 13 directly as the screening element, and to this end to arrange it in the through-opening 9 at least over part of its axial width, wherein the control magnet then has the at least one permanent magnet on its end side and cooperates by means of its end side facing towards the interior of the gearing housing 8 with at least one sensor (e.g. Hall sensor or chip) which protrudes radially above the board 11.

### LIST OF REFERENCES

1 armature shaft
2 commutator
3 brush holder
4 carbon brush
5 board
6 board opening
7 container
8 gearing housing
8.1 housing flange
9 through-opening in the housing flange 8.1 for the armature shaft
10 bearing for the armature shaft
11 board in the gearing housing
12 sensor
13 control magnet
14, 16, 17 section
15, 15a screening element or bushing
18, 19 section
20, 21 recess or chamber
21 web

1. An electromotive drive comprising an electric motor with a commutator which is located in a motor housing, and also gearing which is flange-mounted on the electric motor, wherein a shaft which is driven by the electric motor, passes through an opening into an interior of a gearing housing, characterized in that a screening element is fixed onto the shaft to rotate with said shaft, and in that the screening element completely or almost completely closes the opening by means of a first section which is circular or cylindrical at the circumference.

2. The electromotive drive according to claim 1, characterized in that at least one control magnet is provided on the shaft within the gearing housing, which control magnet rotates with the shaft and cooperates with at least one sensor which is preferably arranged within the gearing housing.

3. The electromotive drive according to claim 1, characterized in that the first section extends into the opening.

4. The electromotive drive according to any claim 1, characterized in that the first section closes the opening up to an annular gap having a width which is much smaller than the diameter of the opening.

5. The electromotive drive according to claim 1, characterized in that the shaft is the armature shaft of the electric motor.

6. The electromotive drive according claim 1, characterized in that the shaft is mounted in the gearing housing, and in that the corresponding bearing is offset axially relative to the opening which is screened off from the motor interior by means of the screening element.

7. The electromotive drive according to claim 1, characterized in that the screening element is at the same time a carrier or hub for the at least one control magnet.

8. The electromotive drive according to claim 7, characterized in that the at least one control magnet is provided on the screening element in a manner offset axially with respect to the first section.

9. The electromotive drive according to claim 1, characterized in that at least one sensor which cooperates with the control magnet is provided on a board which is accommodated in the gearing housing.

10. The electromotive drive according to claim 1, characterized in that the screening element is a molded part made of plastic.

11. The electromotive drive according to claim 1, characterized in that the screening element, in addition to the first section, has at least one second section which is offset axially with respect to the first section, wherein the at least one control magnet is arranged on said second section and/or said second section forms the at least one control magnet.

12. The electromotive drive according to claim 1, characterized in that the first and second section of the screening element directly adjoin one another.

13. The electromotive drive according to claim 1, characterized in that a sleeve-shaped section which surrounds the shaft is provided between the first section and the second section.

14. The electromotive drive according to claim 1, characterized in that the screening element or the first section of this element forms part of the commutator.

15. The electromotive drive according to claim 1, characterized in that the control magnet forms the screening element.

16. The electromotive drive according to claim 15, characterized in that the control magnet extends into the through-opening with at least part of its axial width.

17. A screening element for use with an electric motor having a motor housing having a magnet and at least one sensor therein, said motor housing being capable of receiving gearing and comprising an opening through which a motor shaft having a commutator may pass; said screening element comprising:
a first section fixed onto or integrally formed with said shaft and being generally circular or cylindrical at its circumference; and
said first section becoming situated in operative relationship with said opening and being dimensioned to substantially close said opening when said shaft is received in said housing such that said first section becomes situated between said commutator and said at least one sensor.

18. The screening element as recited in claim 17 wherein said screening element of said first section forms at least a part of said commutator.

19. The screening element as recited in claim 17 wherein said screening element is defined by the magnet.

20. The screening element as recited in claim 17 wherein said screening element is at least partially situated in said opening.
